(19) United States
(12) Patent Application Publication
(10) Pub. No.: US 2015/0096940 A1
(43) Pub. Date: Apr. 9, 2015

(54) WATER TREATMENT PROCESS

(71) Applicant: Orica Australia Pty Ltd, Melbourne, Victoria (AU)

(72) Inventors: Miguel Salvador Arias-Paic, Boulder, CO (US); Kelly Bryan Mccurry, Parker, CO (US)

(21) Appl. No.: 14/403,334

(22) PCT Filed: May 24, 2013
(86) PCT No.: PCT/AU2013/000549

§ 371 Date: Nov. 24, 2014

Related U.S. Application Data
(60) Provisional application No. 61/651,866, filed on May 25, 2012.

(30) Foreign Application Priority Data
Apr. 12, 2013 (AU) 2013204708

(51) Int. Cl. C02F 1/42

(52) U.S. Cl. CPC C02F 1/42; C02F 2001/427
USPC 210/677; 210/670; 210/263

(57) ABSTRACT

The present invention relates to water treatment, in particular to a process for the removal of contaminants in a raw water source where the contaminants consist of organic species and inorganic species.

### FIELD OF THE INVENTION

The present invention relates to water treatment, in particular to a process for the removal of contaminants in a raw water source where the contaminants consist of organic species and inorganic species.

### BACKGROUND OF THE INVENTION

The processes used in water treatment are largely a function of raw water quality. Raw water supplies for drinking water (potable water) often contains unacceptably high levels of organic and inorganic species. For instance, such water supplies often contain unacceptably high levels of organic compounds dissolved, dispersed or suspended in raw water. These organic compounds are referred to herein as Natural Organic Matter (NOM). Other terms used to describe NOM include total organic carbon (TOC), dissolved organic matter (DOM), dissolved organic carbon (DOC), organic colour, colour and aquatic material absorbing ultraviolet light at a wavelength of 254 nm, among other wavelengths of interest (270 nm, 290 nm, etc.). DOC often includes compounds such as humic and fulvic acids among other weakly charged polyelectrolyte compounds. Humic and fulvic acids are not discrete organic compounds but mixtures of organic compounds from allocthonous; incomplete decomposition of plant and animal life and autochtanous sources resulting from photosynthesis and decomposition of detritus. The removal of DOC from water is necessary in order to provide high quality water suitable for distribution and consumption. A majority of the compounds and materials which constitute DOC are soluble and are not readily separable from the water. The DOC present in raw water renders conventional treatment techniques (coagulation and flocculation) difficult, and renders modern techniques (ultrafiltration, nanofiltration and reverse osmosis) wasteful in terms of raw water waste, and expensive. In addition to these organic carbon species, raw water sources often contain unacceptable levels of inorganic species such as calcium and magnesium (which engenders “hardness” to the water), bromide, ammonia, sulfate, sulfide, nitrate, cyanide, copper, mercury, arsenic, etc.

Having two or more inorganic/organic undesirable species means that most raw water sources contain ions which either may compete or may foul during any water treatment operation involving ion exchange or adsorption processes. In addition other competing ions such as silicate and bicarbonate are also typically present, and an ion, sulfate and DOC for example, that may be targeting in one process may be of competition concern during another process. As an example, strong base anion exchange resins, such as the magnetic ion-exchange MIEX® resin of Orica Australia Pty. Ltd. described in U.S. Pat. No. 5,900,146, can be used to partially remove inorganic anions, and dependent on water quality, can typically have over six times the affinity for sulfate as for arsenate. However, in the presence of large quantities of DOC, the ability of MIEX® to effectively remove such inorganic species (which are usually present in smaller quantities) can be negligible. To do so often requires an adsorption/flocculation/aggregation step to remove the DOC first.

For example, in Florida, United States, there are many water supplies that have high DOC and hardness (ie calcium and magnesium) concentrations. These plants have traditionally used a lime softening technology to remove hardness. Lime softening is a well proven technology, but produces large quantities of large sludge that is expensive to dispose of.

The removal of some toxic inorganic ionic species from water down to the parts-per-billion (ppb) level is necessary in order to provide high quality water suitable for distribution and consumption. For example, EPA standards currently require no more than 50 μg/L (50 ppb) arsenic in drinking water. The following table lists limits for some inorganic contaminants that are required to be removed for either health or aesthetic reasons.

| | | | |
|---|---|---|---|
| | Australian: | US-EPA: | WHO: |
| | (Drinking | (Drinking | (Drinking |
| | Water | Water | Water |
| Contaminant | Guidlines) | Standards) | Standards) |

| | | | |
|---|---|---|---|
| Mg²⁺ | N/A | N/A | N/A |
| Ca²⁺ | N/A | N/A | N/A |
| Mg²⁺ + Ca²⁺ | N/A | N/A | N/A |

| SO₄²⁻ | 250 | mg/L | 250 | mg/L | N/A | |
|---|---|---|---|---|---|---|
| Bromate- | 0.02 | mg/L | 0.01 | mg/L | 0.01 | mg/L |

| | | | | | |
|---|---|---|---|---|---|
| Cyanide (as | 0.08 | mg/L | 0.2 | mg/L | N/A |
| free cyanide) | | | | | |

| | | | |
|---|---|---|---|
| SCN⁻ | N/A | N/A | N/A |

| Hg²⁺ | 0.001 | mg/L | 0.002 | mg/L | 0.006 | mg/L |
|---|---|---|---|---|---|---|
| Copper | 2 | mg/L | 1.3 | mg/L | 2 | mg/L |
| Lead | 0.01 | mg/L | 0 | | 0.01 | mg/L |
| Cadmium | 0.02 | mg/L | 0.05 | mg/L | 0.03 | mg/L |
| Barium | 2 | mg/L | 2 | mg/L | 0.7 | mg/L |
| Heavy metals | | | | | | |
| CrVI | 0.05 | mg/L | 0.1 | mg/L | 0.05 | mg/L |
| NO₃⁻ | 50 | mg/L | 10 | mg/L | 50 | mg/L |

| | | | |
|---|---|---|---|
| NH₄⁺ | N/A | N/A | N/A |
| PO₄²⁻ | N/A | N/A | N/A |

Removal of contaminating inorganic anions by ion exchange in the presence of competing ions such as sulfate, silicate, nitrate, bicarbonate and dissolved organic carbon compounds present in the water has not heretofore been widely adopted primarily because the competing ions exhaust the resin before significant amounts of the target inorganic anions (e.g., bromide or arsenate) have been removed, or because the ion exchange process is carefully calibrated and constantly readjusted to account for small concentration differences in raw water sources, there is a significant risk of breakthrough and chromatographic peaking events, especially for less selective ions. Thus, frequent regeneration of the ion-exchange resin, which requires a need for redundancy designed into the process, in addition to multiple Wending scenarios between target contaminants, and the need for careful monitoring of the process can make removal of such contaminating ions by means of ion exchange resin operation too difficult to be viable. For example, a hardness removal process that requires that 75% of the hardness be removed, and the maximum quantity of DOC be removed would require several vessels; one for each type of resin at the different blend rates (25% bypass for hardness, 0% bypass for DOC removal) and two extra vessels would be required for a total of 4 vessels.

When silicate is present as a competing ion, fouling of the ion exchange resin is a severe problem in inorganics removal by means of ion exchange columns. In such cases, the resin particles become coated with polymerised silicate, leading to an impenetrable layer of solid material on and near the surface of the bed, decreasing the system flux, and/or coating the resin surface yielding the resin useless, resulting in the columns becoming inoperable for inorganic ionic species removal. Similarly, contaminant species such as organic matter can foul cation exchange resins, by means of adsorption or metal bridging between the resin and DOC, ultimately coating surfaces, blocking cationic exchange to occur and allowing for bacterial growth to take place. This is often the case where both anionic and cationic species of concern are present in the same raw water source to be treated by the art of ion exchange. In this case, the aforementioned ions of concern need to be reduced to manageable levels and competing ions need to either selectively not be removed or be removed in levels that do not compete with the removal of the target ions. This is necessary to produce water that is within regulatory compliance and aesthetically pleasing.

Therefore a need exists to develop a water treatment process which can simply and economically remove both organic and inorganic ionic species contaminants from water while substantially eliminating breakthrough, chromatographic peaking and fouling events. The present invention seeks to provide such a process.

### SUMMARY OF THE INVENTION

In an aspect the invention further provides a method for removing a contaminant consisting of organic species and inorganic species from water containing an unacceptably high concentration of said contaminant, said method comprising:
a) dispersing a mixture of (i) a magnetic ion exchange resin or other magnetic adsorbing media (‘first medium’) capable of adsorbing said organic species and (ii) a magnetic or non-magnetic ion exchange resin or other adsorbing media (‘second medium’) capable of adsorbing said inorganic species, in the water for a time and under conditions sufficient to absorb a quantity of said contaminant from the water;
b) separating said mixture of ion-exchange resins or adsorbing media loaded with said contaminant;
c) optionally repeating steps a) and b) until such a time as the concentration of said contaminant is acceptable; and
d) regenerating the separated mixture loaded ion-exchange resins or adsorbing media from step b).

In an embodiment the aforementioned method is conducted in a single ion exchange (or contacting) vessel, optionally operating in a batch or continuous manner.

In an embodiment the aforementioned method said first medium settles at a different rate than said second medium, whereby the first and second media are stratified such that the first media is selectively removable from the dispersion without substantially removing the second media and vice versa.

In a further embodiment of the aforementioned method the method may further comprise:
d′) selectively regenerating said first and second media at different rates dependent on the respective adsorptive capacities of said first and second media.

In a further aspect the invention provides a method for removing a contaminant consisting of organic species and inorganic species from water containing an unacceptably high concentration of said contaminant, said method comprising:
a) dispersing a mixture of (i) a first ion exchange resin or other adsorbing medium capable of adsorbing said organic species (“the first medium”) and (ii) a second ion exchange resin or other adsorbing medium capable of adsorbing said inorganic species (“the second medium”), in the water for a time and under conditions sufficient to adsorb a quantity of said contaminant from the water;
wherein said first medium settles at a different rate than said second medium, whereby the first and second media are stratified such that the first medium is selectively removable from the dispersion without substantially removing the second medium and vice versa.

The method may further comprise:
b) selectively regenerating said first and second media at different rates dependent on the respective adsorptive capacities of said first and second media.

In an embodiment the aforementioned method is conducted in a single ion exchange (or contacting) vessel, optionally operating in a batch or continuous manner.

In another aspect the invention provides a method for removing a contaminant consisting of organic species and inorganic species from water containing an unacceptably high concentration of said contaminant, said method comprising:
a) dispersing a mixture of (i) a first ion exchange resin or other adsorbing medium capable of adsorbing said organic species (“the first medium”) and (ii) a second ion exchange resin or other adsorbing medium capable of adsorbing said inorganic species (“the second medium”), in the water for a time and under conditions sufficient to adsorb a quantity of said contaminant from the water; and
b) stratifying said first and second media such that the first medium and/or the second medium are selectively removable from the dispersion.

In certain embodiments, the first medium has a different settling rate than the second medium, such that the stratification occurs naturally by settling. For example, the first medium may have a different density and/or particle size than the second medium. Alternatively, or in addition, the first medium may be a magnetic ion exchange resin while the second medium is a non-magnetic ion exchange resin or other adsorbing medium which settles at a different rate. Advantageously, a magnetic ion exchange resin tends to agglomerate and settle faster than a non-magnetic medium (of equivalent particle size and density). Further, it facilitates separation by application of an external magnetic field, for example by bringing permanent magnets into proximity of a process tank in which the dispersion is held, or by switching on an electromagnet positioned on or near the tank.

By stratifying the media to allow selective removal, it becomes possible to withdraw the different media at different rates for regeneration. The respective withdrawal rates can be dynamically adjusted according to the characteristics of the water under treatment. For example, if it is known that high levels of hardness (e.g. greater than 200 mg/L) are present, the cation exchange resin can be withdrawn for regeneration at a greater rate than the anion exchange (DOC removal) resin, since the cation exchange resin will tend to become loaded more rapidly than the anion exchange resin, which will also in general have higher adsorbing capacity.

In a further aspect the invention provides an, apparatus for removing a contaminant consisting of organic species and inorganic species from water containing an unacceptably high concentration of said contaminant, said apparatus comprising:
a vessel for receiving the water, the vessel comprising at least one inlet to receive a first ion exchange resin or other adsorbing medium capable of adsorbing said organic species (“the first medium”) and a second ion exchange resin or other adsorbing medium capable of adsorbing said inorganic species (“the second medium”), wherein said first medium settles at a different rate than said second medium, such that the first and second media stratify within the vessel at an interface level;
a first pump with an inlet positionable at a height within the vessel above the interface level; and
a second pump with an inlet positionable at a height within the vessel below the interface level; and
a controller for operating the first and second pumps to selectively draw off a quantity of the first medium and/or a quantity of the second medium.

In an embodiment which is relevant to all aforementioned aspects the mixture is a mixture of (i) a magnetic ion exchange resin and (ii) non-magnetic ion exchange resin or other adsorbing media.

In a further embodiment which is relevant to all aforementioned aspects the mixture is a mixture of (i) a magnetic ion exchange resin and (ii) adsorbing media.

In relation to the aforementioned two embodiments it is preferred that the magnetic ion exchange resin is capable of adsorbing said organic species.

In a further embodiment which is relevant to all aforementioned aspects step a) is conducted in a single vessel (“contacting vessel”) and the regenerantion step is also conducted in a single vessel.

In an embodiment the regeneration step involves a pH adjustment step using an acid and/or a base to augment the regeneration or to minimize the potential to foul one medium or both media.

In an embodiment the regeneration step involves an initial separation step of the two types of resins or one type of resin and one type of adsorbing media by density and for size difference. The media (ion exchange and/or absorbent) may be segregated (e.g. by stratification) within a single regenerating vessel to permit application of target regenerants or specific regeneration mechanics to each media separately. The media may then be homogenized and dispersed.

In an embodiment the regeneration step involves segregating the media within the dispersal and thereby permitting regeneration of each media sequentially in a single regeneration vessel or simultaneously in more than one regeneration vessel.

In an embodiment the regeneration step involves reuse of the regenerant either by feed and bleed or by multiple reuse and batch disposition. It may further involve segregation of the reused regenerant permitting minimization of fouling potential.

### BRIEF DESCRIPTION OF FIGURES

FIG. 1 is an Example of a Treatment Process according to the invention; and

FIG. 2 is a schematic of an apparatus for carrying out an exemplary treatment process.

### DESCRIPTION OF THE INVENTION

The process is especially suited for treating water to make it acceptable for human consumption as drinking water but may be used for other beneficial uses such as in mining applications, for instance, treating tailings water. As used herein the term “unacceptably high concentration” refers to an undesirable amount of the contaminant based on limits adopted by individual jurisdictions. Such limits may conform to those mentioned in the “Background of the Invention” section for Australian, US-EPA or WHO standards. It will be appreciated that the “contaminant” refers to both the organic species and inorganic species referred to in the claims which follow. Therefore acceptable levels of the inorganic species is likely to be different from the acceptable levels of the organic species. Also, the raw water may contain various inorganic species and accordingly the acceptable levels of each of these species may vary. It is an aim of the present method to provide water which conforms to acceptable limits for each of the organic and inorganic species as they are found in the raw water source.

Surprisingly, it has been found that both organic and inorganic contaminants can be removed simultaneously by a mixture of ion exchange resins or adsorbing media capable of adsorbing said organic and inorganic species, in a single vessel using a batch or continuous flow water treatment process system. Conventionally, the removal of such contaminants has been approached in a step-wise fashion with separate ion exchange columns to first remove the organic-contaminant component (which is generally in a greater abundance) and then a separate subsequent removal step for the targeted inorganic contaminant. Running separate systems in this manner has, until now, been deemed necessary because it was believed in the art that the quantity of organics would foul or diminish the efficiency of the other resins and it would be too tedious to optimise the regeneration process. For example this was particularly deemed to be the case for removing hardness (e.g., Mg²⁺ and Ca²⁺ ions) as these ions have been reported to cause scaling of the organics resin often decreasing their efficiency. Accordingly, it was deemed that the efficiency of a single mixture approach would be less than a sequential approach.

As stated in the background section, frequent regeneration of the ion-exchange resin, which requires a need for redundancy designed into the process, in addition to multiple blending scenarios between target contaminants, and the need for careful monitoring of the process can make removal of such contaminating ions by means of ion exchange resin operation too difficult to be viable. For example, a hardness removal process that requires that 75% of the hardness be removed, and the maximum quantity of DOC be removed would require several vessels; one for each type of resin at the different blend rates (25% bypass for hardness, 0% bypass for DOC removal) and two extra vessels would be required for a total of 4 vessels. The following table illustrates this:

| | Conven- | Conven- | Conven- | Conven- | |
|---|---|---|---|---|---|
| | tional | tional | tional | tional | Process |
| | Fixed | Mixed | Fixed | Mixed | of the |
| | Bed | Bed | Bed | Bed | present |
| | (Duty/ | (Duty/ | (Duty | (Duty/ | inven- |
| System | Standby) | Standby) | only) | Standby) | tion |
| Number of | 4 | 2 | 2 | 1 | 1 |
| Ion Exchange | | | | | |
| Vessels | | | | | |
| Able to run | Yes | Yes | No | No | Yes |
| continuously? | | | | | |
| Able to adjust | Yes | No | Yes | No | Yes |
| bed volume | | | | | |
| treatment rates | | | | | |
| (BVTR)? | | | | | |

The present inventors have surprisingly found that this is not the case with the single ion-exchange mixture process of the present invention providing the same outcome, or at times a potentiation, when compared to a sequential or multi-vessel approach. The benefits of the single ion exchange mixture process means a reduction in capital expenditure, process time efficiency, lower waste volume of regenerant, a higher efficiency in the regeneration sequence and the capability of controlling the regeneration rate for specific resins; and therefore controlling the removal of said contaminants. As shown in the above table in a conventional mixed bed ion exchange unit one would require at least 4 ion exchange vessels for co-removal, for example two to remove organics (e.g., DOC) and two to remove inorganics. For example, if one desired to remove as much DOC as possible and 100 ppm hardness (Mg²⁺ and Ca²⁺) the user would conventionally need to blend for the hardness reduction and that the flow be first treated through the DOC column. When one vessel went into regeneration the other one would come online; therefore redundancy for both would be required. There is no way around doing this in one conventional vessel. The present invention now makes it possible to achieve, for instance, variable hardness reduction and as much DOC removal as possible, in addition to a variable DOC removal in a single vessel.

The process of this invention is capable of treating water having unacceptably high levels of inorganic and organic species in a simultaneous single vessel batch process or simultaneous single vessel continuous process using a mixture of resins, i.e., concentrations greater than acceptable concentrations permitted by law or recommended health standards for water intended for the purpose for which the water is to be used.

Certain embodiments of the method involve contacting or dispersing water containing contaminating ions (“contaminant”) with a mixture or blend of ion exchange resins or other adsorbing media with different ion exchange site chemistry, and preferably a magnetic ion exchange resin and a non-magnetic ion-exchange resin, in a process container (or contacting vessel), removing the mixture of ion exchange resins from the contacting or process container, for example by flowing water from the process container into a separator, settler or concentrator where either magnetic or non-magnetic resin is agglomerated or concentrated and settles to the bottom of the container for separation; then removing and regenerating a portion or all of the separated resin mixture and recycling both the remaining separated resin mixture and the regenerated resin to the process container. In another embodiment, the process container may include a separator or settler therein, e.g., where a settling basin is used and resin mixture separated at the separating end is continuously pumped back to the front end for exposure to the water flow, as in PCT Publication WO 96/07615 incorporated herein by reference, and the high rate system as in PCT/AU2005/001901.

Contaminating inorganic ionic species can be removed down to any desired concentration. If monitoring the treated water shows an unacceptably high level of the undesired inorganic ionic species, the process may be repeated. When a single pass through the process container and settler does not remove the contaminating ions down to the desired level, more resin can be added to the system, a greater portion of the resin can be regenerated during a given time period, or the process can be repeated in the original equipment.

One of the significant advantages of the present process is the ability to easily adjust operation of the process to ensure that the level of contaminants are brought within acceptable or desirable concentrations. This was particularly evident during pilot plant trials that experienced wide variations in raw water quality (e.g. due to high rainfall or varying mineral deposits). However, the process operation could be quickly controlled or optimised to ensure there was no deterioration in final water quality.

There are two main process parameters for improving or reducing (as desired) the performance of the treatment process involving:

1. Increase/decrease the concentration of resin in the “contacting or dispersing step”.
2. increase/decrease the rate of resin regeneration.

Used in isolation or together, both of these options will increase or reduce the effectiveness of the treatment step by changing the effective ion exchange/absorption capacity. To simplify the control process, the methods used for modifying the process performance have been incorporated into a single operation variable called the “bed volume treatment rate” (BVTR).

The BVTR is defined in terms of bed volumes (BV), i.e., the volume of resin required to treat a specific volume of water. For example, a treatment of 100 BV is equivalent to an effective treatment of 20 mL's of resin treating 2000 mL's (2.0 litres) of raw water.

$$\begin{matrix}Bed Volume Treatment Rate = \frac{Volume of raw water in jar test ( mL )}{Volume of resin ( {}_{}^{‵}{media}{}_{}^{′} ) in jar test ( mL )} \\ = \frac{2000 mL}{20 mL} \\ = 100 BV\end{matrix}$$

Therefore increasing the regeneration frequency can be achieved by reducing the BVTR.

For instance, in oune embodiment for the removal of hardness (Mg²⁺+Ca²⁺) (in the presence of DOC) down to a level of <200, ppm the BVTR is between 25-5000, for instance 50-3000, 100-2000, 200-1000, 300-800, 300-700, 300-600, or 300-500.

In an embodiment the ratio mixture of magnetic ion exchange resin (for organic removal) to non-magnetic ion exchange resin/absorbent (for inorganic removal) is about 95:5, about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, about 10:90, or about 5:95 (the ratio determined on a % wt/wt bases of the total resin amount). In addition to having specific ratios of resin in the process aforementioned herein, it may only be necessary to employ only the amount of resin that is required for treatment goals or the other extreme of employing excess resin in the treatment process. The flexibility of the invention allows for either regeneration rate or resin concentration or both regeneration rate and resin concentration to dictate contaminant removal.

The process container (or contacting vessel) in which the process can be conducted may be any container known to the art for treating water and includes process tanks used for batch-wise or continuous processes, as well as conduits. Water may be placed in a process container or flowed into a process container by any means known to the art, e.g., by pumping or gravity feed.

The ion-exchange resin particles for organic removal are preferably magnetic and that they preferably have a diameter less than about 250 μm, more preferably in the range of from about 50 μm to about 200 μm. Particles in this size range can be readily dispersed in the water and are suitable for subsequent separation from the water. The size of the resin particles affects the kinetics of adsorption of organic species and the effectiveness of separation. The optimal size range for a particular application can be readily determined by one skilled in the art without undue experimentation.

The magnetic ion-exchange resin particles can have a discrete magnetic core or have magnetic particles dispersed throughout the resin particles. In resin particles which contain dispersed magnetic particles it is preferred that the magnetic particles are evenly dispersed throughout the resin particles.

It is preferred, although not required, that the ion-exchange resin particles be macroporous in order to provide the particles with a large surface area onto which the inorganic ionic species can be adsorbed. Macroporous (or macroreticular) is a term known to the art as applied to the bead structure of certain ion exchange resins which have a rigid structure with large discrete pores, typically manufactured using a porogen.

In another embodiment, the ion exchange resin (or one resin in the blend) is a strong or weak base ion exchange resin such as those described in PCT Publication WO 03/057739 published Jul. 17, 2003, and the inorganic ionic species contaminant is selected from the group including sulfide ion, bicarbonate, sulfate, selenate, copper, cadmium, cobalt, mercury, zinc, and other inorganic anions known to the art to be capable of being removed by such ion exchange resins.

In a further embodiment, the ion exchange resin (or one resin in the blend) is a strong or weak acid ion exchange resin known to the art, and the inorganic ionic species contaminant is selected from the group including sodium, potassium, nickel, calcium, magnesium, manganese, iron, cobalt, and other inorganic cations known to the art to be capable of being removed by such ion exchange resins.

In a still further embodiment, the ion exchange resin (or one resin in the blend) is a weak acid ion exchange resin known to the art and the inorganic ionic species contaminant is selected from the group including sodium, potassium, calcium, magnesium, manganese, copper, and nickel, and other inorganic cations known to the art to be capable of being removed by such ion exchange resins.

The water treatment process of this invention preferably involves contacting contaminant containing raw water sources with resins either through hydraulic distributor design or agitation. The mixture of resin particles is dispersed with water so as to expose the contaminant species in the process container to maximum surface area on the resin. Agitation and/or plug flow regeneration (as per PCT/AU2005/001111) is also preferred during resin regeneration so as to expose the regenerant solution to maximum surface area on the resin being regenerated. In the processes of this invention, water containing the resin particles can also be flowed and/or pumped and subjected to other operations that can deleteriously affect the ion-exchange resin. It is therefore preferred that the resin be manufactured in such a way, with a significant degree of crosslinkage, so as to form polymeric particles that are tough but not brittle. Toughening agents may be used as known to the art and as disclosed in PCT Publication WO 03/057739. Thus, the magnetic particles dispersed throughout the polymeric beads of the preferred embodiment are not easily removed from the beads during conveying, pumping and mixing.

A preferred magnetic ion exchange resin MIEX® resin of Orica Australia Pty. Ltd. Inc. described in U.S. Pat. No. 5,900,146.

The MIEX® ion exchange resin, are also capable of adsorbing inorganic ionic species having a higher selectivity than chloride, generally in accordance with the following indicative increasing Order of Selectivity (Table 1).

TABLE 1

Fluoride < Acetate < Formate < Iodate < Dihydrogen Phosphate <
Bicarbonate < Hydroxide < Bromate < Chloride < Cyanide <
Bisulfite ≈ Nitrite < Bromide < Nitrate < Bisulfate < Iodide <
Sulfate < Chromate < Perchlorate

However in the context of the present invention this ion exchange will be negligible because of the amount of DOC present relative to the inorganic contaminant. As such, it is important that to remove such inorganics or organics, the invention requires separate inorganic and organic targeting resins (or ‘media’).

Specific combinations of contaminants and resins are enclosed below in Table 2:

TABLE 2

| | | Ion- | | | |
|---|---|---|---|---|---|
| | Contaminant | exchange | Contaminant | | Example ion |
| | (organic) | resin | (inorganic) | Resin types | exchange resin |
| 1. | DOC | MIEX | Mg²⁺ | SAC, WAC | Purolite C100, |
| | | | | | Purolite C150, |
| | | | | | Purolite C104, |
| | | | | | Lewatit S1567 |
| 2. | DOC | MIEX | Ca²⁺ | SAC, WAC | Purolite C150, |
| | | | | | Purolite C100, |
| | | | | | Purolite C104, |
| | | | | | Lewatit S1567 |
| 3. | DOC | MIEX | Mg²⁺ +/or | SAC, WAC | Purolite C100, |
| | | | Ca²⁺ | | Purolite C150, |
| | | | | | Purolite C104, |
| | | | | | Lewatit S1567 |
| 4. | DOC | MKEX | Mg²⁺ + Ca²⁺ | SAC, WAC | Purolite C150, |
| | | | | | Purolite C100, |
| | | | | | Purolite C104, |
| | | | | | Lewatit S1567 |
| 5. | DOC | MIEX | SO₄²⁻ | SBA | Purolite A300E, |
| | | | | | Purofine PFA503, |
| | | | | | Amberlite PWA15, |
| | | | | | Dowex Marathon A |
| 6. | DOC | MIEX | Br⁻ | SBA | Mitsubishi NSA100, |
| | | | | | Mitsubishi PA316, |
| | | | | | Purolite Bromide |
| | | | | | Plus, Purolite |
| | | | | | A172/4635 |
| 7. | DOC | MIEX | Cyanide | SBA, WBA | Lewatit K6462, |
| | | | metal | | DOW IRA-958 |
| | | | complexes | | Lewatit MP62 |
| 8. | DOC | MIEX | SCN⁻ | Adsorption | Lewatit FO36, |
| | | | | resin, SBA | Purolite P250, |
| 9. | DOC | MIEX | Hg²⁺ | Chelation | Purolite S920, |
| | | | | resins | DOW-XUS 43604, |
| | | | | | DOWEX G-26(H), |
| | | | | | Lewatit Monoplus |
| | | | | | TP214 |
| 10. | DOC | MIEX | Heavy | Chelation | LewatitTP207, |
| | | | metals (eg | resins | DOWEX M4195, |
| | | | Cu, Pb, Ni, | | Purolite S930, |
| | | | Zn, V, Cd, | | Purolite S940 |
| | | | Sr, Ba, U) | | |
| 11. | DOC | MIEX | Cr^{VI} | WBA, SBA | DOWEX1, |
| | | | | | DOWEX SAR, |
| | | | | | DOWEX 21 K |
| | | | | | XLT, |
| | | | | | Purolite S106 |
| 12. | DOC | MIEX | NO₃⁻ | SBA | Purolite A520E, |
| | | | | | Lewatit SR7, |
| | | | | | DOWEX NSR-1, |
| | | | | | DOWEX PSR-3 |
| 13. | DOC | MIEX | NH₄⁺ | SAC, WAC | DOW MAC-3, |
| | | | | | DOWEX G-26, |
| | | | | | Purolite C150, |
| | | | | | Purolite C145, |
| 14. | DOC | MIEX | PO₄²⁻ | Adsorption | Lewatit FO36, |
| | | | | resin, SBA, | Purolite A300, |
| | | | | Chelation | DOWEX |
| | | | | resin doped | M4195(Cu-form), |
| | | | | with copper | Dowex Marathon A |

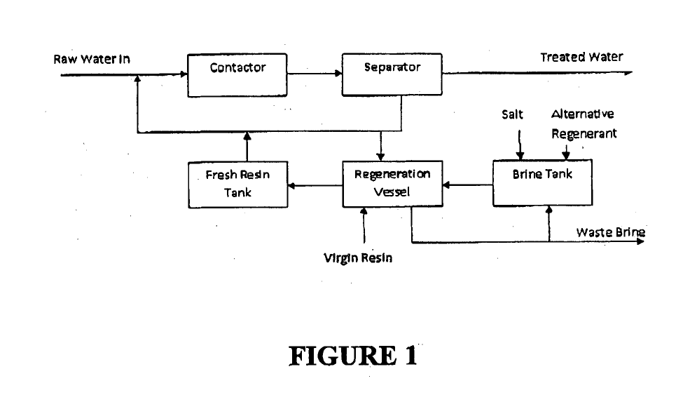

Loaded ion exchange resin (also referred to herein as “used ion exchange resin”) is resin on which some or all available sites have been taken up by contaminant or competing ions from the water. Loaded resin may still have sites available for taking up contaminant ions. Exhausted ion exchange resin has substantially all its available sites occupied and in equilibrium with raw water contaminant levels, such that the exhausted resin is substantially unable to take up or exchange additional ions from the water. Preferably, loaded ion exchange resin, which may or may not include exhausted ion exchange resin, is regenerated, e.g., by contacting it with a regenerant solution, such as a saline solution, preferably brine or a HCl solution (or another alternative regenerant depending upon the resin or absorbtion media), and returning it to the process container as “regenerated ion exchange resin”. Any used ion exchange resin that is not regenerated can be reused in the process, this being referred to herein as “recycled resin”. Ion exchange resin added to any process container to replace that which is lost to the process in treated water and/or removed for regeneration is referred to herein as “replacement resin”. Replacement ion exchange resin includes regenerated resin, and brand new resin which has not previously been used in the process but which is added to make up for loss of resin from the process in product water, and is herein referred to as “virgin resin”. The virgin resin may be added directly to the process container or may be added to a replacement resin holding container also containing regenerated resin, which is supplied to the process container (see FIG. 1).

In contrast to previously-known ion exchange processes for removal of inorganic ionic species, the process of this invention prevents breakthrough and chromatographic peaking. In these previously-known processes, it is essential to be able to predict the time at which the ion exchange resin in the column will be completely exhausted, so that it can be taken off line and replaced with a fresh column. Complete exhaustion of the ion exchange resin in the column means that the amount of contaminating ion in the effluent from the column is the same as that in the influent to the column, while chromatographic peaking can yield concentrations higher than those of raw water levels for partial portions of the effluent as resins become more loaded towards exhausted. The concentration of the contaminating ion in the effluent rises rapidly when the column becomes completely exhausted. However, there are no rapid in-line methods for accurately measuring the concentration of many contaminating ions (such as arsenic) in the effluent stream. Typically, effluent stream concentrations of contaminating ions are analysed at different time points as part of process design, and the time at which effluent concentration of contaminating ion equals a predetermined fraction of the known concentration of contaminating ion in the influent stream (the breakthrough point) is used to predict when the columns should be taken off line. This will be a time slightly earlier than the breakthrough point. However, if the concentration of contaminating ion increases in the influent stream while the process is running, actual breakthrough will occur earlier than the predicted breakthrough point, and by the time the column has been taken off line, the concentration of the contaminating ion in the effluent stream will exceed desirable levels. Thus, previous ion exchange processes for inorganic ionic species removal carry a risk of releasing contaminated water to water supplies meant for human consumption.

This breakthrough phenomenon can also occur with other adsorption media whereby weakly held contaminants can be displaced from the media and discharged into the effluent. Transient conditions such as changes in hydraulics and changes in competing species concentration can result in premature breakthrough in conventional packed bed columns.

Chromatographic peaking occurs when contaminating ions are being removed by conventional column ion exchange processes in the presence of competing ions for which the ion exchange resin has greater selectivity. In these processes, competing ions in water flowing into the top of the column load the resin at the top of the column and once the competing ions have been removed from the water, the contaminating ions load the resin lower in the column. As water continues to enter the column, competing ions will replace contaminating ions already loaded on the resin, and the contaminating ions will continue to move lower on the column. The resin will continue to remove contaminating ions until all the resin has become exhausted. At this point, the resin will not remove any more contaminating ions, and the competing ions will continue to replace the contaminating ions already loaded on the resin, so that the effluent will contain not only the contaminating ions that were present in the influent stream, but also the contaminating ions being displaced from the resin by competing ions. The effluent concentration of contaminating ions will temporarily be even greater than the influent concentration. As is the case with breakthrough, the problem arises in accurately predicting when chromatographic peaking will occur so that the column can be taken off line before that time. An increase in competing and/or contaminating ion concentration in the influent stream can cause chromatographic peaking to occur earlier than predicted, with potentially disastrous results for the quality of the effluent water.

The process of this invention prevents breakthrough and chromatographic peaking because replacement mixtures of ion exchange resins and adsorbent media are constantly being supplied to the process and loaded media is constantly removed from the process for regeneration or discharged, thus preventing a situation in which all the media is exhausted at once.

As stated in the background section, frequent regeneration of the ion-exchange resin, which requires a need for redundancy designed into the process, in addition to multiple blending scenarios between target contaminants, and the need for careful monitoring of the process can make removal of such contaminating ions by means of ion exchange resin operation too difficult to be viable. For example, a hardness removal process that requires that 75% of the hardness be removed, and the maximum quantity of DOC be removed would require several vessels; one for each type of resin at the different blend rates (25% bypass for hardness, 0% bypass for DOC removal) and two extra vessels would be required for a total of 4 vessels. The following table illustrates this:

| | Conven- | Conven- | Conven- | Conven- | |
|---|---|---|---|---|---|
| | tional | tional | tional | tional | Process |
| | Fixed | Mixed | Fixed | Mixed | of the |
| | Bed | Bed | Bed | Bed | present |
| | (Duty/ | (Duty/ | (Duty | (Duty/ | inven- |
| System | Standby) | Standby) | only) | Standby) | tion |
| Number of | 4 | 2 | 2 | 1 | 1 |
| Ion Exchange | | | | | |
| Vessels | | | | | |
| Able to run | Yes | Yes | No | No | Yes |
| continuously? | | | | | |
| Able to adjust | Yes | No | Yes | No | Yes |
| bed volume | | | | | |
| treatment rates | | | | | |

The process of this invention further prevents rapid fouling of ion exchange resin, e.g., by silicates, because the movement of the resin particles in circulation in the process lines and containers negates the opportunity for the polymerisation and fouling which occurs on packed, stationary resin beds.

The process of this invention further provides for combinations of media leading to improved contaminant removal efficiencies via the simultaneous removal of competing species. An example of this is removal of sulphate competing ion using one ion exchange resin combined with MIEX resin for DOC removal. As sulphate, at certain concentrations, will compete with DOC for MIEX exchange sites, the co-removal of the sulphate improves the DOC removal efficiencies.

Other purposes for which water treated by this process may be used include industrial applications, mining applications, remediation and food processing applications, as well as waste water treatment.

It is preferred that the process be conducted continuously, adjusting flow rates and/or resin dose as necessary, until the level of inorganic and organic species contaminants is within acceptable levels. The process may also be conducted batch-wise, and repeated as necessary to reach desired purity levels.

In one embodiment, water is continuously flowed into the process container and out of the process container, and replacement resin is periodically added to the process container. In another embodiment, water is continuously flowed into and out of the process container, and replacement resin is also continuously added to the process container. In these continuous processes, water is preferably flowed into and out of the process container at a rate of about one process container volume every 2 to 40 minutes. Recycled resin is also preferably added to the process container continuously.

In another embodiment, water is flowed into the process container periodically, and recycled and replacement resins are added to the process container periodically.

The process is effective for removing a range of target ions in the presence of a range of possible competing ions.

In continuous processes of this invention, it is, important that sufficient replacement resin be added to the process in a timely manner to prevent exhaustion of the resin, i.e., loading of substantially all the sites on the ion exchange resin particles in the process container with contaminant ions and competing ions. Exhaustion of the resin, when substantially all the sites on the resin particles are loaded with contaminant ions, means that subsequent removal of the target contaminant will effectively cease. Preferably, an equal amount of replacement resin is added to the process container to offset the loaded resin being removed from the process for regeneration.

The amount of regenerated resin that is returned to the process, which is “sufficient to remove said inorganic and organic species contaminants in said water down to acceptable concentrations,” can be an amount which is at least the minimum required for this purpose, and preferably this amount includes no more than about 20% excess over the minimum required, more preferably no more than about 10% excess.

If the competing ions are taken up on the resin in preference to the inorganic ionic species contaminants (i.e., if the ion exchange resin has greater selectivity for the competing ions than for the inorganic ionic species contaminants), and/or if competing ion concentration in the water is greater than inorganic ionic species contaminant concentration, the process can be operated continuously, in contrast to previously-known ion exchange resin column processes, by adding more resin to the process until the effluent concentration of the selected inorganic ionic species to be removed reaches desired levels.

In batch-wise processes, the water must remain in contact with the mixture of ion exchange resins for a period long enough to take up the required amount of the contaminant, but not so long as to favour replacement of these ions on the resin by competing ions. Preferably, the contact time in batch processes is in the range about 2 minutes to about 40 minutes.

Process parameters, i.e., resin dose, contact time, and regeneration rate, can be determined by one skilled in the art for any given process, applying art-known principles and the teachings of this specification. Exemplary process parameters for particular processes are provided in the Examples hereof.

In a typical process, no more than about 0.01% percent by volume of the ion exchange resin mixture will be lost in the purified water stream. Virgin resin is then added to the process container as needed to replace the resin that is lost. The balance of the replacement resin required for the ongoing process is regenerated resin. Resin lost to downstream processes may be further reduced by use of a filter unit to capture resin in the stream exiting any container that is used to contain resin and from which resin may be lost.

The resin is regenerated in a batch process, or continuously as described hereinafter, by contact with a regenerant solution capable of causing the inorganic ionic species contaminants to be displaced from the resin. For example, this may occur by using a regenerant solution that alters the pH (e.g. HCl) or other chemical property of the system, thereby removing or altering the interaction between the resin and the contaminant, upon which the contaminant dissolves or is otherwise sequestered in the regenerant and/or waste solution.

Alternatively, the regenerant solution may contain an ion that is capable of directly displacing the contaminant from the resin. The ion in the chosen regenerant solution may not be preferred by the resin in terms of its selectivity, but in this event it needs to be present in sufficient concentration in the regenerant solution to make the displacement effective. In the latter case, the concentration of the regenerant solution is preferably between about 1% and about 20% of the salt containing the displacing ion.

Preferably this ion is chloride, and the regenerant solution is a brine solution. The term “brine” means any high concentration salt solution capable of causing the desorption of species from the media. High concentration saline solutions, e.g., at least about 10% NaCl and often saturated, which are one form of brine, are particularly useful as regenerating fluids in the present process, particularly where strong base resins are used. This is particularly advantageous for the combination DOC and reducing hardness or removing sulphate or bromide as a single brine renegerant is able to regenerate both ion exchange resins in the mixture.

Typically, the resin can be regenerated and reused indefinitely without having to change the total resin inventory, since the small amount of resin loss to the system and its replacement with virgin resin maintains the condition of the total inventory over the long term.

Loaded resin is regenerated in a resin regenerator where it is contacted with the regenerant solution, e.g., brine, and from thence the regenerated ion exchange resin is conveyed back to the process container as replacement resin, or to a holding container from which it is conveyed to the process container. In one embodiment of this invention, two resin regenerators can be used so that when a first regenerator is full, loaded resin underflow from the process container or resin separator can be directed to the second regenerator. The resin regenerator may be an external column using a regenerant solution to regenerate the ion exchange resin, or a separate regeneration container, which may be a fixed bed (plug flow) or a container with an agitator to disperse the resin, in which resin is contacted with the regenerant solution, such as by adding the loaded magnetic ion-exchange resin to the solution, dispersing it in the solution, agglomerating the regenerated magnetic ion exchange resin, and separating the regenerated resin from the regenerant solution. Regeneration may be performed continuously or batch-wise. The ratio of regenerant fluid to ion exchange resin slurry is preferably between about 1:1 to about 10:1, more preferably between about 2:1 and about 5:1.

In batch processes, the process container may be used as the resin regenerator after removal of the purified water, by adding saline regenerant solution to the process tank, as described in U.S. patent Publication No. US 2002/0121479 A1.

The solution used to regenerate the ion exchange resin may be reused, and typically can be reused between about 5 and about 25 times. Typically, about 0% to about 20%, and more preferably about 1% to about 10% volume percent of the recycled regenerant solution is taken off to waste per use. Make-up regenerant solution can be added to the regeneration container or to a separate regenerant solution supply vessel to replace the volume taken off in the waste stream. The remainder of the used regenerant solution can be recycled to the regenerant solution supply vessel or the regeneration container for reuse. Combining the two ion-exchange resins in a single mixture means that the regeneration process may use less regenerant.

Any portion of the solution containing contaminants that is removed as a liquid waste stream from the used regenerant solution exiting the regeneration container can be further treated by a method known to the art such as ferric precipitation, membrane separation, flash distillation, or spray evaporation, in order to remove the contaminant from the liquid waste.

In the process of the present invention the amount of ion-exchange resin or adsorbent media necessary to remove contaminant species from water is dependent on a number of factors including the level of inorganic ionic species initially present in the water to be treated, the nature of the inorganic ionic species, the desired level of inorganic ionic species in the treated water, type and concentration of competing ions, salinity, total alkalinity, hardness, temperature, pH, and the rate at which it is desired to treat the water to remove the inorganic ionic species.

Preferred ion-exchange resins are recyclable and regenerable. Recyclable resins can be used multiple times without regeneration and continue to be effective in adsorbing inorganic species. Regenerable resins are capable of treatment to remove adsorbed inorganic ionic species from the resin, and such regenerated resins Can then be re-introduced into the treatment process. Depending on water quality, only a small portion of the resin needs to be regenerated before recycling, e.g., about 20% or less, or more preferably, 10% or less. The amount of resin to be recycled depends on the contaminating inorganic ionic species, the level and type of competing ions, the amount of contaminating ions in the water to be treated, and percent removal required to achieve the desired purity in the treated water. In general, a higher percent removal of inorganic ionic species is required in the treatment of drinking water than the percent removal required for dissolved organic compounds (DOCs).

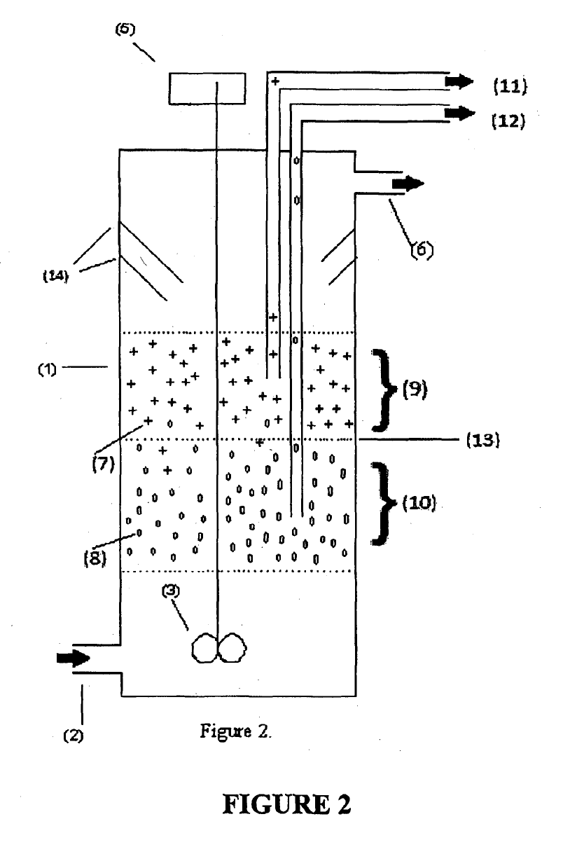

FIG. 2 depicts a process tank or apparatus (1) of one embodiment of the invention. It includes a raw water inlet pipe (2), an optional agitator with connected motor (4) and an optional settler enhancement system (e.g. lamella plate array (14)) to facilitate stratification. The apparatus includes an outlet (6) where water flows out through the outlet. This outflowing water maybe subject to further treatment steps if required.

The apparatus further includes air lift pumps (11) and (12) which are positioned inside the tank to a height suitably above and below the interface (13) of two types of resins or adsorbing media (7) and (8) which are characterised with varying densities. The varying densities create a stratification of the two types of resins and this is depicted as (9) and (10).

Due to differences in density and/or particle size and/or magnetic properties, particles of the two different adsorbing media settle at different rates and stratify into two strata (as shown in FIG. 2, 9 vs 10), It will be appreciated that the boundary or interface between the two strata is not sharply defined, since there may be an intermediate region between the strata in which the two particle types are commingled. For the purposes of determining the heights at which to place the airlift pumps (11, 12), the interface (shown in FIG. 2 as (13)) between the strata may be defined as a nominal horizontal plane, such that the ratio of the concentration of the first particle type to the second particle type is a maximum on one side of the nominal plane and is a minimum on the other side of the nominal plane. The nominal plane may be determined by numerical simulations, or empirically by pilot studies or by deploying sensors which measure the optical or electromagnetic properties of the strata in real time, and which may provide information to actuators to shift the airlift pump positions if necessary.

The air lift pumps serve to remove resin or adsorbent media for regeneration which can be a separate regeneration process or the two types of resins combined for a joint regeneration process.

The process of the present invention is readily incorporated into existing water treatment facilities. For example, it may be used upstream of processes such as conventional coagulation, sedimentation/filtration, filtration, membranes or any combination of processes as the water quality, treatment requirements or other circumstances dictate.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

### EXAMPLES

### Example 1

Hardness & DOC removal: This example utilised a strong cation resin (Purolite C100EFM) in conjunction with a strong base anion exchange resin (MIEX, DOC). Pilot scale results (10 gpm system) demonstrated that total hardness as well as calcium hardness can be removed by the process, of the present invention even to significant levels by greatly increasing the regeneration frequency. Increasing the regeneration frequency is achieved by reducing the bed volume treatment rate, leading the more fresh (regenerated) resin being used to treat a set water volume (E.g. 1000 mL of water get treated by 2 mL of fresh resin, equaling to 500 By treatment rate (1000 mL/2 mL=500 BV). In this case at 1000 BV treatment rate, over the period of the 25 Feb. 2012 to 1 Mar. 2013 the total hardness was reduced from 360-500 mg/L down to 160-240 mg/L. While when running the plant at 300 BV on the 2 Mar. 2012, the total hardness was reduced from 445 mg/L down to 34 mg/L.

| | | | | | | Calcium - H (mg CaCO3/L) | | | | |
|---|---|---|---|---|---|---|---|---|---|---|
| | | | Total -H (mg CaCO3/L) | | | | | Total | | |
| | | | | MIEX- | Total | | MIEX - | Calcium | DOC | |
| | | | | Co- | Hardness | | Co- | Hardness | (mg-C/L) | |
| Date | Time | Well | Raw | Removal | Removal | Raw | Removal | Removal | Raw | MIEX |
| Feb. 25, 2012 | 12:00 | 7 | 420 | 200 | 220 | 380 | 180 | 200 | 6.62 | 1.50 |
| Feb. 26, 2012 | 12:30 | 8 | 500 | 260 | 240 | 360 | 220 | 140 | 5.16 | 1.46 |
| Feb. 27, 2012 | 13:30 | 5 | 460 | 200 | 260 | 400 | 180 | 220 | 6.77 | 1.56 |
| Feb. 27, 2012 | 14:30 | 3 | 360 | 160 | 200 | 340 | 190 | 150 | 6.24 | 1.32 |
| Feb. 28, 2012 | 13:30 | 4 | 360 | 240 | 120 | 300 | 240 | 60 | 8.39 | 1.52 |
| Mar. 1, 2012 | 7:00 | 8 | 411 | 240 | 171 | 342 | 188 | 154 | 4.93 | 1.76 |
| Mar. 1, 2012 | 10:00 | 7 | 377 | 240 | 137 | 411 | 171 | 240 | 5.51 | 1.63 |
| Mar. 1, 2012 | 15:00 | 4 | 359 | 240 | 120 | 342 | 223 | 120 | 8.26 | 1.83 |
| Mar. 2, 2012 | 11:00 | 5 | 445 | 34 | 411 | 411 | 34 | 377 | 6.71 | 1.13 |
| Mar. 3, 2012 | 8:00 | 3 | 185 | 87 | 99 | 240 | 103 | 137 | 6.45 | 1.30 |
| Mar. 8, 2012 | 12:00 | 3, 4 | 274 | 180 | 94 | 239 | 154 | 86 | 5.70 | 1.90 |

### Example 2

Sulfate & DOC removal: Bench-scale tests based on continuous jar testing showed that using MIEX Resin in co-junction with a generic SBA ion exchange resin (Purolite A300E) enhances besides the DOC removal rate also the sulphate removal levels at same bed volume treatment rates. At a 1000 BV the co-use of Purolite A300, reduces the initial sulphate levels from 371 mg/L down to 286 mg/L, while MIEX only reduces the sulphate only down to 364 mg/L. In this case Purolite A300E shows an affinity for sulphate removal, making the overall removal process more efficient.

| | | | Red River (MIEX Alone) | | | | |
|---|---|---|---|---|---|---|---|
| | | | BV Treatment | | | | |
| Parameter | Units | Raw | 1000 | 800 | 600 | 400 | 200 |
| DOC | mg/L | 10.1 | 8.29 | 8.00 | 7.51 | 6.90 | 6.09 |
| UVA | 1/cm | 0.163 | 0.090 | 0.082 | 0.078 | 0.074 | 0.041 |
| Sulfate | mg/L | 370 | 364 | — | — | — | — |

| | | | Co-Removal Red River | | | | |
|---|---|---|---|---|---|---|---|
| | | | (MIEX + Purolite A300E Resin) | | | | |
| | | | BV Treatment | | | | |
| Parameter | Units | Raw | 1000 | 800 | 600 | 400 | 200 |
| DOC | mg/L | 10.7 | 6.95 | 6.76 | 6.48 | 5.99 | 4.88 |
| UVA | 1/cm | 0.166 | 0.074 | 0.069 | 0.065 | 0.062 | 0.045 |
| Sulfate | mg/L | 371 | 286 | 270 | 268 | 234 | 109 |

### Example 3

### Bromide & DOC Removal

Bench-scale tests based on continuous jar testing showed that using MIEX Resin in co-junction with a generic SBA ion exchange resin (Purolite A300E) and a selective WBA ion exchange resin (Purolite A172) could enhance the amount of bromide and sulphate removed. At 400 BV, MIEX only reduced the initial sulphate and bromide levels of 47 mg/L and 220 ug/L down to 36.1 mg/L and 200 ug/L respectively. A mixture of all three resins reduced the sulphate and bromide down to 26.6 mg/L and 140 ug/L respectively, showing a significant improvement in removal when using specific resins in a co-removal process.

DWR Source (MIEX Only)
BV Treatment Rate

| Parameter | Units | Raw | 400 | 200 |
|---|---|---|---|---|
| Bromide | ug/L | 220 | 200 | 140 |
| Sulfate | mg/L | 47 | 36.1 | 21.6 |

| | | | DWR Source (MIEX/A172/A300) | |
|---|---|---|---|---|
| | | | BV Treatment Rate | |
| Parameter | Units | Raw | 400 | 200 |
| Bromide | ug/L | 220 | 140 | 110 |
| Sulfate | mg/L | 47 | 26.6 | 16.7 |

### Example 4

### DOC, Nitrate and Total Hardness Removal

In this bench-scale based jar test trial Nitrate and total hardness were simultaneously removed, by using MIEX Resin (DOC and Nitrate removal) and a generic resin called Purolite C104 (Total hardness removal). The initial total hardness level of 400 mg/L was still reduced down to 197 mg/L at 300 BV treatment rate, and thereby meeting the required maximum drinking water level of 200 mg/L total hardness. At the same time MIEX Resin reduced the initial nitrate level down from 35.42 mg/L down to 24.06 mg/L. The advantage by adding both resins in one removal step allows reducing the treatment steps and thereby potential costs.

BV treatment rate

| Para- | | | | | | | |
|---|---|---|---|---|---|---|---|
| meter | Units | Raw | 100 | 200 | 300 | 400 | 500 |
| DOC | mg/L | 0.9 | 0.6 | 0.7 | 0.7 | 0.7 | 0.8 |
| Nitrate | mg/L | 35.42 | 17.27 | 20.59 | 24.06 | 27.12 | 29.40 |
| Total | mg/L | 400 | 170 | 165 | 197 | 225 | 250 |
| Hard- | | | | | | | |
| ness as | | | | | | | |
| CaCO3 | | | | | | | |

1. A method for removing a contaminant consisting of organic species and inorganic species from water containing an unacceptably high concentration of said contaminant, said method comprising:
a) dispersing a mixture of (i) a magnetic ion exchange resin or other magnetic adsorbing media (‘first medium’) capable of adsorbing said organic species and (ii) a magnetic or non-magnetic ion exchange resin or other adsorbing media (‘second medium’) capable of adsorbing said inorganic species, in the water for a time and under conditions sufficient to absorb a quantity of said contaminant from the water;
b) separating said mixture of ion-exchange resins or adsorbing media loaded with said contaminant;
c) optionally repeating steps a) and b) until such a time as the concentration of said contaminant is acceptable; and
d) regenerating the separated mixture loaded ion-exchange resins or adsorbing media from step b).

2. A method according to claim 1 wherein the method is conducted in a single ion exchange (or contacting) vessel, optionally operating in a batch or continuous manner.

3. A method according to claim 1 or 2 wherein in said method the first medium settles at a different rate than said second medium, whereby the first and second media are stratified such that the first media is selectively removable from the dispersion without substantially removing the second media and vice versa.

4. A method according to any of claims 1 to 3 wherein the method further comprises:
d′) selectively regenerating said first and second media at different rates dependent on the respective adsorptive capacities of said first and second media.

5. A method for removing a contaminant consisting of organic species and inorganic species from water containing an unacceptably high concentration of said contaminant, said method comprising;
a) dispersing a mixture of (i) a first ion exchange resin or other adsorbing medium capable of adsorbing said organic species (“the first medium”) and (ii) a second ion exchange resin or other adsorbing medium capable of adsorbing said inorganic species (“the second medium”), in the water for a time and under conditions sufficient to adsorb a quantity of said contaminant from the water;
wherein said first medium settles at a different rate than said second medium, whereby the first and second media are stratified such that the first medium is selectively removable from the dispersion without substantially removing the second medium and vice versa.

6. A method according to claim 5 further comprising:
b) selectively regenerating said first and second media at different rates dependent on the respective adsorptive capacities of said first and second media.

7. A method according to claim 5 or 6 wherein the method is conducted in a single ion exchange (or contacting) vessel, optionally operating in a batch or continuous manner.

8. A method for removing a contaminant consisting of organic species and inorganic species from water containing an unacceptably high concentration of said contaminant, said method comprising:
a) dispersing a mixture of (i) a first ion exchange resin or other adsorbing medium capable of adsorbing said organic species (“the first medium”) and (ii) a second ion exchange resin or other adsorbing medium capable of adsorbing said inorganic species (“the second medium”), in the water for a time and under conditions sufficient to adsorb a quantity of said contaminant from the water; and
b) stratifying said first and second media such that the first medium and/or the second medium are selectively removable from the dispersion.

9. A method according to claim 8 wherein the first medium has a different settling rate than the second medium, such that the stratification occurs naturally by settling

10. An apparatus for removing a contaminant consisting of organic species and inorganic species from water containing an unacceptably high concentration of said contaminant, said apparatus comprising:
a vessel for receiving the water, the vessel comprising at least one inlet to receive a first ion exchange resin or other adsorbing medium capable of adsorbing said organic species (“the first medium”) and a second ion exchange resin or other adsorbing medium capable of adsorbing said inorganic species (“the second medium”), wherein said first medium settles at a different rate than said second medium, such that the first and second media stratify within the vessel at an interface level;
a first pump with an inlet positionable at a height within the vessel above the interface level; and
a second pump with an inlet positionable at a height within the vessel below the interface level; and
a controller for operating the first and second pumps to selectively draw off a quantity of the first medium and/or a quantity of the second medium.

11. A method according to any one of claims 1 to 10 wherein the mixture is a mixture of (i) a magnetic ion exchange resin and (ii) non-magnetic ion exchange resin or other adsorbing media.

12. A method according to any one of claims 1 to 10 wherein the mixture is a mixture of (i) a magnetic ion exchange resin and (ii) adsorbing media.

13. A method or apparatus according to claim 11 or 12 wherein the magnetic ion exchange resin is capable of adsorbing said organic species.

14. A method according to claim 1 wherein step a) is conducted in a single vessel (“contacting vessel”) and the regeneration step is also conducted in a single vessel.

15. A method according to any one of claims 1 to 14 wherein the contaminant consists of DOC and magnesium ions.

16. A method according to any one of claims 1 to 14 wherein the contaminant consists of DOC and calcium ions.

17. A method according to any one of claims 1 to 14 wherein the contaminant consists of DOC, magnesium ions and calcium ions.

18. A method according to any one of claims 1 to 14 wherein the contaminant consists of DOC and bromide ions.

19. A method according to any one of claims 1 to 14 wherein the contaminant consists of DOC and cyanide ions.

20. A method according to any one of claims 1 to 14 wherein the contaminant consists of DOC and arsenic ions.

21. A method according to any one of claims 1 to 14 wherein the contaminant consists of DOC and sulfate ions.

22. A method according to any one of claims 1 to 14 wherein the contaminant consists of DOC and mercury ions.

23. A method according to any one of claims 1 to 14 wherein the contaminant consists of DOC and nitrate ions.

24. A method according to any one of claims 1 to 23 wherein the magnetic ion exchange resin capable of adsorbing said organic species is MIEX®.

25. A method according to claim 24 wherein the MIEX® resin is MIEX-C1.

26. A method according to any one of claims 1 to 25 wherein the non-magnetic ion exchange resin is selected from a gel ion exchange resin, macroporous ion exchange resin, or macroreticular ion exchange resin.

27. A method according to claim 26 wherein the resin is a Purolite type resin.

28. A method for removing a contaminant consisting of organic and inorganic ionic species from water containing an unacceptably high concentration of said contaminant, said method comprising: dispersing ion exchange resin(s) capable of exchanging said organic and inorganic ionic contaminant in the water; separating a portion of the ion exchange resin loaded with said contaminant in said water down to an acceptable concentration; said resin(s) being regenerated or replaced in amounts sufficient to remove said contaminants, wherein the amount sufficient to remove said contaminant to an acceptable concentration is controlled by varying the Bed Volume Treatment Rate (BVTR).

29. A method according to claim 28 where the regeneration process includes any combination of single and divalent salts including the acidic and basic forms of the salts concentrated or dilute ranging in concentration from a volume percent of 2% to saturation ranging in pH from −3.0 to 14.

30. A method according to claim 28 wherein said ion exchange resin is a magnetic ion exchange resin.

31. A method according to claim 29 wherein said ion exchange resin is a magnetic ion exchange resin.

32. A method according to claim 28 wherein said ion exchange resin is a gel ion exchange resin.

33. A method according to claim 29 wherein said ion exchange resin is a gel ion exchange resin.

34. A method according to claim 28 wherein said ion exchange resin is a macroporous ion exchange resin.

35. A method according to claim 29 wherein said ion exchange resin is a macroporous ion exchange resin.

36. A method according to claim 28 wherein said ion exchange resin is a macroreticular ion exchange resin.

37. A method according to claim 29 wherein said ion exchange resin is a macroreticular ion exchange resin, preferably an absorbent media.

38. A method according to claim 28 also comprising the steps: regenerating said removed portion of ion exchange resin; and periodically or continuously adding said regenerated resin to the water, the regenerated resin and virgin unused resin direct from manufacture forming all or part of the replacement resin.

39. A method according to claim 28 wherein the ion exchange resin is dispersed in the water in a process container.

40. A method according to claim 28 wherein ion exchange resin loaded with said contaminant is transferred from the process container to a separator to allow resin loaded with said contaminants to be regenerated is to be separated from the said water.

41. A method according to claim 40 wherein separated resin loaded with said contaminants is recycled back with or without going through the regeneration process to the process container.

42. The method of claim 23 wherein said portion of the ion exchange resin loaded with said contaminants is separated for regeneration is separated from the loaded resin being recycled back to the process container.

43. The method of claim 16 in which contaminated water is continuously or periodically flowed into and out of said process, and said replacement ion exchange resin is continuously or periodically added to said process in an amount sufficient to prevent exhaustion of substantially all ion exchange resin in said process.

44. The method of claim 17 in which said ion exchange resin is in the basic form of an ion exchange resin, and exchanges said inorganic and/or organic ionic contaminant.

45. The method of claim 18 wherein said ion exchange resin is in the acidic form of an ion exchange resin and exchanges said inorganic and/or organic ionic contaminant.

46. The method of claim 16 in which said water contains competing ions capable of being exchanged by said ion exchange resin.

47. The method of claim 16 in which the ratio of raw water to be treated to ion exchange resin slurry in said process is between about 3.3:1 to about 199:1.

48. The method of claim 20 wherein said regeneration is performed by contacting said resin with a regenerant solution.

49. The method of claim 22 in which water is flowed into and out of said process at a rate of about one process container volume every 2 to 40 minutes.

50. The method of claim 23 wherein said magnetic ion exchange resin is MIEX®, resin.

51. The method of claim 24 wherein said regenerant solution is recycled to the regeneration step at least about 1 to about 25 times.

52. The method of claim 24 also comprising treating a waste stream comprising said regenerant solution used to regenerate said ion exchange resin, by removal of said ionic species contaminants.

53. The method of claim 28 also comprising treating filtered water effluent of said process.

54. The method of claim 28 also comprising said water is degassified.

55. The method of claim 54 wherein said water is degassified prior to being placed in said process container.

56. The method of claim 54 wherein said water is degassified prior to removal of said ion exchange resin thereafter.

57. The method of claim 54 wherein said water is chemically treated prior to removal of said ion exchange resin thereafter.

58. The method of claim 28 wherein water removed from said process is placed in a second process and said method steps are repeated.

59. A method for removing a contaminant consisting of DOC and Bromide from water containing an unacceptably high concentration of said contaminant, said method comprising:
a) dispersing a mixture of (i) a magnetic ion exchange resin or other adsorbing media capable of adsorbing said DOC and (ii) a magnetic or nonmagnetic ion exchange resin or other adsorbing media capable of adsorbing said Bromide, in the water for a time and under conditions sufficient to absorb a quantity of said contaminant from the water;
b) separating said mixture of ion-exchange resins loaded with said contaminant; and
c) optionally repeating steps a) and b) until such a time as the concentration of said contaminant is acceptable.

60. A method for removing a contaminant consisting of DOC and Bromide from water containing an unacceptably high concentration of said contaminant, said method comprising:
a) dispersing a mixture of (i) a magnetic ion exchange resin or other adsorbing media capable of adsorbing said DOC and (ii) a magnetic or non-magnetic ion exchange resin capable or other adsorbing media capable of adsorbing said Bromide, in the water for a time and under conditions sufficient to absorb a quantity of said contaminant from the water;
b) separating said mixture of ion-exchange resins loaded with said contaminant;
c) optionally repeating steps a) and b) until such a time as the concentration of said contaminant is acceptable; and
d) regenerating the separated mixture loaded ion-exchange resins from step b).

61. A method according to claim 59 and claim 60 wherein the mixture of (i) and (ii) is (i) MIEX and (ii) generic SBA ion exchange resin (preferably Purolite A300E).

62. A method according to claim 59 and claim 60 wherein the mixture of (i) and (ii) is (i) MIEX and (ii) generic SBA ion exchange resin (preferably Purolite A300E) and selective WBA ion exchange resin (preferably Purolite A172).

63. A method according to any one of claims 59 to 62 wherein the ratio of (i) to (ii) is about 20:80.

64. A method for removing a contaminant consisting of organic species and inorganic species from water containing an unacceptably high concentration of said contaminant, said method comprising:
a) dispersing a mixture of (i) a magnetic ion exchange resin or other magnetic adsorbing media (‘first medium’) capable of adsorbing said organic species and (ii) a magnetic or non-magnetic ion exchange resin or other adsorbing media (‘second medium’) capable of adsorbing said inorganic species, in the water for a time and under conditions sufficient to absorb a quantity of said contaminant from the water;
b) separating said mixture of ion-exchange resins or adsorbing media loaded with said contaminant;
c) optionally repeating steps a) and b) until such a time as the concentration of said contaminant is acceptable; and
d) regenerating the separated mixture loaded ion-exchange resins or adsorbing media from step b),
wherein the organic species is DOC and the inorganic species is total hardness (Mg²⁺ and Ca²⁺)

65. A method according to claim 64 wherein the method is conducted in a single ion exchange (or contacting) vessel, optionally operating in a batch or continuous manner.

66. A method according to claim 64 or 65 wherein in said method the first medium settles at a different rate than said second medium, whereby the first and second media are stratified such that the first media is selectively removable from the dispersion without substantially removing the second media and vice versa.

67. A method according to any of claims 64 to 66 wherein the method further comprises:
d′) selectively regenerating said first and second Media at different rates dependent on the respective adsorptive capacities of said first and second media.

68. A method for removing a contaminant consisting of organic species and inorganic species from water containing an unacceptably high concentration of said contaminant, said method comprising:
a) dispersing a mixture of (i) a first ion exchange resin or other adsorbing medium capable of adsorbing said organic species (“the first medium”) and (ii) a second ion exchange resin or other adsorbing medium capable of adsorbing said inorganic species (“the second medium”), in the water for a time and under conditions sufficient to adsorb a quantity of said contaminant from the water,
wherein said first medium settles at a different rate than said second medium, whereby the first and second media are stratified such that the first medium is selectively removable from the dispersion without substantially removing the second medium and vice versa,
wherein the organic species is DOC and the inorganic species is total hardness (Mg²⁺ and Ca²⁺).

69. A method according to claim 68 further comprising:
b) selectively regenerating said first and second media at different rates dependent on the respective adsorptive capacities of said first and second media.

70. A method according to claim 68 or 69 wherein the method is conducted in a single ion exchange (or contacting) vessel, optionally operating in a batch or continuous manner.

71. A method for removing a contaminant consisting of organic species and inorganic species from water containing an unacceptably high concentration of said contaminant, said method comprising:
a) dispersing a mixture of (i) a first ion exchange resin or other adsorbing medium capable of adsorbing said organic species (“the first medium”) and (ii) a second ion exchange resin or other adsorbing medium capable of adsorbing said inorganic species (“the second medium”), in the water, for a time and under conditions sufficient to adsorb a quantity of said contaminant from the water; and
b) stratifying said first and second media such that the first medium and/or the second medium are selectively removable from the dispersion, wherein the organic species is DOC and the inorganic species is total hardness (Mg²⁺ and Ca²⁺)

72. A method according to claim 71 wherein the first medium has a different settling rate than the second medium, such that the stratification occurs naturally by settling

73. An apparatus for removing a contaminant consisting of organic species and inorganic species from water containing an unacceptably high concentration of said contaminant, said apparatus comprising:
a vessel for receiving the water, the vessel comprising at least one inlet to receive a first ion exchange resin or other adsorbing medium capable of adsorbing said organic species (“the first medium”) and a second ion exchange resin or other adsorbing medium capable of adsorbing said inorganic species (“the second medium”), wherein said first medium settles at a different rate than said second medium, such that the first and second media stratify within the vessel at an interface level;
a first pump with an inlet positionable at a height within the vessel above the interface level; and
a second pump with an inlet positionable at a height within the vessel below the interface level; and
a controller for operating the first and second pumps to selectively draw off a quantity of the first medium and/or a quantity of the second medium,
wherein the organic species is DOC and the inorganic species is total hardness (Mg²⁺ and Ca²⁺)

74. A method or apparatus according to any one of claims 64 to 73 wherein the mixture is a mixture of (i) a magnetic ion exchange resin and (ii) non-magnetic ion exchange resin or other adsorbing media.

75. A method or apparatus according to any one of claims 64 to 73 wherein the mixture is a mixture of (i) a magnetic ion exchange resin and (ii) adsorbing media.
